(19) United States
(12) Patent Application Publication
(10) Pub. No.: US 2010/0003553 A1
(43) Pub. Date: Jan. 7, 2010

(54) Method for improved efficiency for producing fuel gas for power generation

(76) Inventor: William C. Pfefferle, Madison, CT (US)

Correspondence Address: Robert L. Rispoli;Precision Combustion, Inc., 410 Sackett Point Road, North Haven, CT, 06473, US

(21) Appl. No.: 12/381,949

(22) Filed: Mar. 17, 2009

Related U.S. Application Data
(60) Provisional application No. 61/070,357, filed on Mar. 20, 2008.

(51) Int. Cl. H01M 8/04; F02C 3/28; F02C 7/00; C10J 3/00

(52) U.S. Cl. 429/17; 60/780; 60/783; 48/210

(57) ABSTRACT

A method is provided for maximizing the production of electrical energy from coal by improving the thermal efficiency of gasifiers used in integrated coal gasification combined cycle gas turbine (IGCC) systems. Coal is reacted in a gasifier to produce a product fuel gas containing carbon monoxide from combustion of the carbon of the feed coal, plus additional carbon monoxide from the reduction of carbon dioxide, wherein the reaction of carbon monoxide with water is avoided to conserve the work potential of the product fuel gas which will increase the efficiency of conventional gas turbine systems and high temperature fuel cells. Combustion of the product fuel gas with oxygen produces carbon dioxide which is readily recovered from the exhaust by removal of water, such as from combustion of hydrogen in the coal, and molecular hydrogen from the coal may recovered by permeation through a hydrogen permeable membrane.

### CROSS-REFERENCE

This application claims the benefit of U.S. Provisional Application No. 61/070,357 filed Mar. 20, 2008.

### FIELD OF THE INVENTION

The present invention relates to a method for maximizing the production of electrical energy from coal by improving the thermal efficiency of gasifiers used in integrated coal gasification combined cycle gas turbine (IGCC) systems. In particular, the present invention comprises a method for maximizing the preservation of coal heating values and enabling low cost recovery of carbon dioxide.

### BACKGROUND OF THE INVENTION

### Brief Description of the Related Art

With energy usage directly related to economic growth, there has been a steady increase in the need for increased energy supplies. In the U.S., coal is abundant and low in cost. Unfortunately, conventional coal-fired steam plants, which are a major source of electrical power, are inefficient and pollute the air. Thus, there is a pressing need for cleaner, more efficient coal-fired power plants. Accordingly, IGCC systems have been developed which can achieve significantly improved efficiencies in comparison to conventional steam plants.

In an IGCC system, syngas (a mixture of hydrogen and carbon monoxide) is produced by partial oxidation of coal or other carbonaceous fuel in the presence of water. This process allows cleanup of sulfur and other impurities before combustion. If carbon sequestration is desired, the carbon monoxide is reacted with steam using the water gas shift reaction to form carbon dioxide and hydrogen. Carbon dioxide may then be recovered using conventional technologies known in the art. This allows pre-combustion recovery of carbon dioxide for sequestration.

Regardless of whether carbon dioxide is recovered or whether air or oxygen are used for syngas production, hydrogen is typically derived from water fed to the system. For every mole of hydrogen produced, approximately 15% of the Lower Heating Value (LHV) energy is lost. The result is a syngas having a reduced LHV, i.e. work potential, as compared to the original coal.

IGCC systems still are more efficient than steam plants even though in steam plants combustion of coal releases all the heating value of the coal. An advantage of IGCC systems is that mercury can be removed, typically with an adsorber bed. Although this avoids the stack gas mercury emissions of a conventional steam plant the spent adsorbent represents a hazard waste for disposal. Thus there is a need for a gasification system which not only utilizes all of the coal heating value but also allows ready recovery of carbon dioxide for sequestration.

### DESCRIPTION OF THE INVENTION

The present invention is a method of gasifying coal to produce a product fuel gas containing carbon monoxide from combustion of the carbon of the feed coal plus additional carbon monoxide from the reduction of carbon dioxide. In contrast to current IGCC syngas technology, this approach substitutes carbon dioxide for water and produces carbon monoxide from reaction of coal with carbon dioxide, avoiding the consequent loss of LHV energy that is entailed in H₂ production. This leaves more energy available for use downstream in an energy production process or power generation apparatus such as a gas turbine or a fuel cell. Note that methods for gasifying coal are commonly referred to as producing a “fuel gas”. Applicant refers to the product of gasifying coal as having produced a “product fuel gas” for the description provided herein. In the present invention, reaction of carbon monoxide with water is avoided to conserve the work potential of the product fuel gas. Thus it is advantageous for the coal to be relatively dry and therefore to avoid adding water to the coal before use. “Dry coal” in the embodiments of the present invention comprises a supply of coal without a deliberate addition of water. It may contain incidental water. Added water will cause losses in product fuel gas LHV. This will reduce the efficiency benefit that would have accrued from using no added water. In general, efficiency losses resulting from the latent heat of deliberately added water should be limited to no more than about three percent. It may also be beneficial to further dry the coal, if the energy and cost of doing so is less than the improvement in total product fuel gas LHV.

The increased work potential of the fuel gas can lead to fuel-to-power efficiencies significantly higher, e.g. five to ten percent or more, than conventional IGCC designs. Losses to latent heat of water are not required as in conventional systems. Combustion of the product fuel gas with pure oxygen produces carbon dioxide which is readily recovered from the exhaust by removal of water (such as from combustion of hydrogen in the coal). Moreover, molecular hydrogen from the coal may recovered by permeation through a hydrogen permeable membrane. Typically, operating pressures are in excess of twenty or thirty atmospheres, and pressures of a hundred atmospheres offer advantages.

In a method of the present invention, coal, oxygen, and carbon dioxide are fed to an oxygen-blown gasifier operating at a high temperature, typically well over 1800° F. in order to produce a product fuel gas containing at least about five percent or preferably at least fifteen percent more moles of carbon monoxide than moles of carbon in the feed coal. A catalyst such as potassium carbonate may be used.

To capture impurities in the ash, operating temperature must be sufficiently above the ash melting point, typically 100° F. or more, so that molten ash can be quenched in a water pool as in conventional gasifiers, forming a glassy frit and encapsulating ash toxics. The produced steam may be used to produce hydrogen without latent heat penalty, since the quench provides the needed latent heat of vaporization. This recovers a portion of the slag heat. However, the steam produced may be fed to a steam turbine. In proposed systems, mercury may be sequestered underground with the product CO₂ rather than collected on an adsorbent creating a hazardous waste for disposal. Sulfur can be recovered from the exhaust. However, conventional mercury and sulfur recovery systems may be used. In this case the product fuel gas is cooled such as by dilution with recycled carbon dioxide to eliminate the need for a high temperature (high cost) heat exchanger or by heat exchange to raise the temperature of the CO₂ being input to the gasifier. Product fuel gas may also be cooled by expansion as in a turbine.

In one example of an application of the present invention, a dry coal having an analysis of 0.37 moles of hydrogen per mole of carbon is fed to a slagging gasifier along with 0.2 moles of carbon dioxide and 0.42 moles of oxygen per mole of carbon in the coal. Molten ash is removed and quenched in a water bath. Product fuel gas exits the gasifier at about a temperature in excess of 3000° F. Gas analysis shows 1.18 moles of carbon monoxide per mole carbon in the feed coal and more than 0.34 moles of hydrogen. On a mole fraction basis the product fuel gas is 75 percent carbon monoxide and 22 percent molecular hydrogen with only about one percent carbon dioxide remaining. Typically, the product fuel gas contains less than about thirty percent unconverted carbon dioxide. After filtration to remove ash dust and cooling of the product fuel gas to about 1400° F., high purity hydrogen may be recovered by passage through a permeation unit, e.g. the permeation unit of U.S. Pat. No. 3,344,586. Combustion of the carbon monoxide-rich gas with oxygen allows ready capture of carbon dioxide.

### BRIEF DESCRIPTION OF THE DRAWINGS

FIG. 1 provides a schematic of an IGCC system in accordance with the present invention showing convention mercury and sulfur removal and the use of CO₂ for product fuel cooling.

FIG. 2 provides a schematic of an IGCC system in accordance with the present invention without mercury and sulfur removal from the product fuel gas.

FIG. 3 provides a schematic of an IGCC system in accordance with the present invention showing the production of a product fuel gas in order to supply fuel to a fuel cell.

FIG. 4 provides a schematic of an IGCC system in accordance with the present invention similar to that shown in FIG. 1 showing that air instead of oxygen.

### DETAILED DESCRIPTION OF THE INVENTION

Gasifier product fuel gas represents a high fuel-value fuel containing nearly all the Lower Heating Value energy of the original coal in the form of carbon monoxide and heat. As fuel to an energy production process or power generation apparatus such as a gas turbine or an oxide fuel cell, overall thermal efficiency from coal is at least about five percent higher than conventional coal gasifier systems.

For fuel cell use, conventional mercury capture and sulfur recovery is applicable in order to avoid poisoning the fuel cell. Use of carbon monoxide, as with hydrogen, in an oxide transport fuel cell provides a basically reversible anode:

CO+O==CO₂+2e

CO₂ capture for sequestration is inherent with combustion of anode gas bleed with oxygen, particularly high purity oxygen, producing only CO₂ and water. Note that the fuel cell can operate at gasifier pressure or at a lower pressure following expansion of the hot syngas in a power recovery turbine to adjust the inlet temperature. The anode bleed gas is typically combusted with oxygen and fed to a heat recovery boiler or to a power recovery turbine producing carbon dioxide for sequestration and for recycle. The fuel cell cathode may be supplied with either air or pure oxygen.

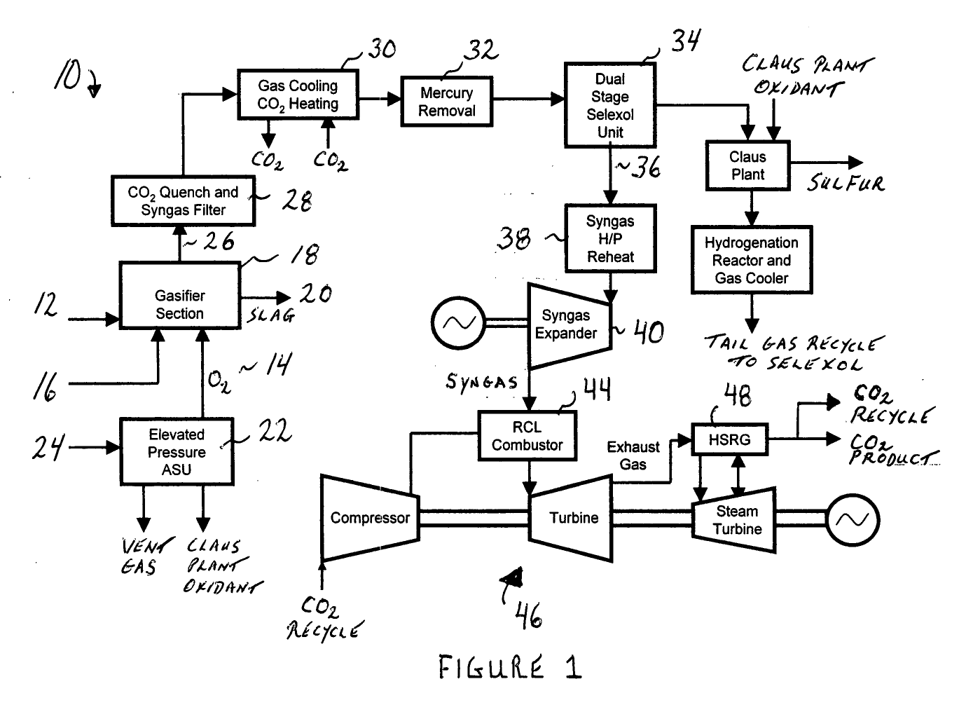

FIG. 1 represents a simplified schematic diagram of an oxygen-blown IGCC system 10. As shown, coal 12, oxygen 14 and carbon dioxide 16 are fed to gasifier 18. Numerous gasifier designs have been developed including entrained flow, fluidized bed systems and countercurrent flow designs. Ash or slag 20 is removed for disposal as water quenched slag as in conventional gasifier systems. Oxygen is supplied by an air separation plant 22 which may be a membrane separator or more typically an air liquefaction plant.

Feed air 24 is typically compressed using intercooler compressors. Raw syngas 26 is passed through a quench and filter device 28, cooled in a heat exchanger 30, and passed through mercury and/or sulfur recovery units 32 and 34 for removal of mercury, sulfur and other contaminates. Cleaned product fuel gas 26 is reheated 38, expanded 40, mixed with oxygen 42, combusted 44 and passed to a conventional IGCC system 46. Combustor 44 may comprise any conventional combustor; however, a preferred embodiment comprises a rich catalytic reactor for reaction of the fuel prior to downstream combustion such as that disclosed in U.S. Pat. No. 6,394,791. Lastly, CO₂ is recovered 48 by condensing water.

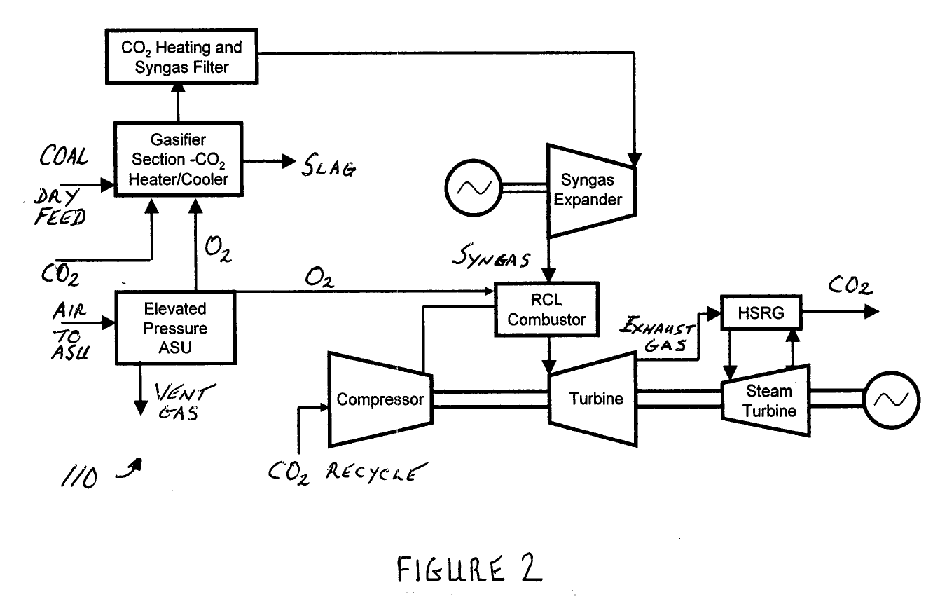

FIG. 2 represents IGCC system 10 in accordance with the present invention without the mercury and sulfur recovery units. Mercury and sulfur is sequestered along with carbon dioxide. This eliminates significant energy losses, and with inherent carbon dioxide sequestration, disposes of mercury and sulfur along with carbon dioxide. The mercury hazardous waste issue is eliminated.

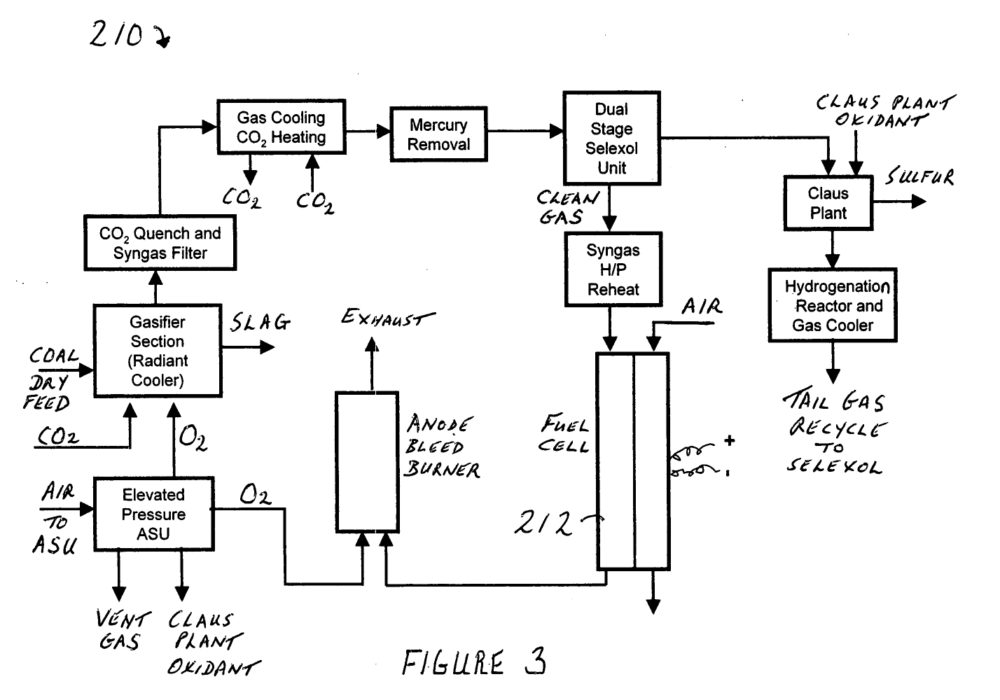

FIG. 3 represents IGCC system 210 in accordance with the present invention utilizing a solid oxide fuel cell 212 rather than a gas turbine for electrical power generation. Anode gas bleed is combusted with oxygen and the hot effluent is fed to a power turbine for energy recovery. Either air or oxygen may be used a cathode oxidant. If air is used the hot cathode bleed gas may be used to generate steam for energy recovery. If oxygen is used, the oxidant bleed gas may be used for anode bleed combustion. Efficiencies over sixty percent are possible.

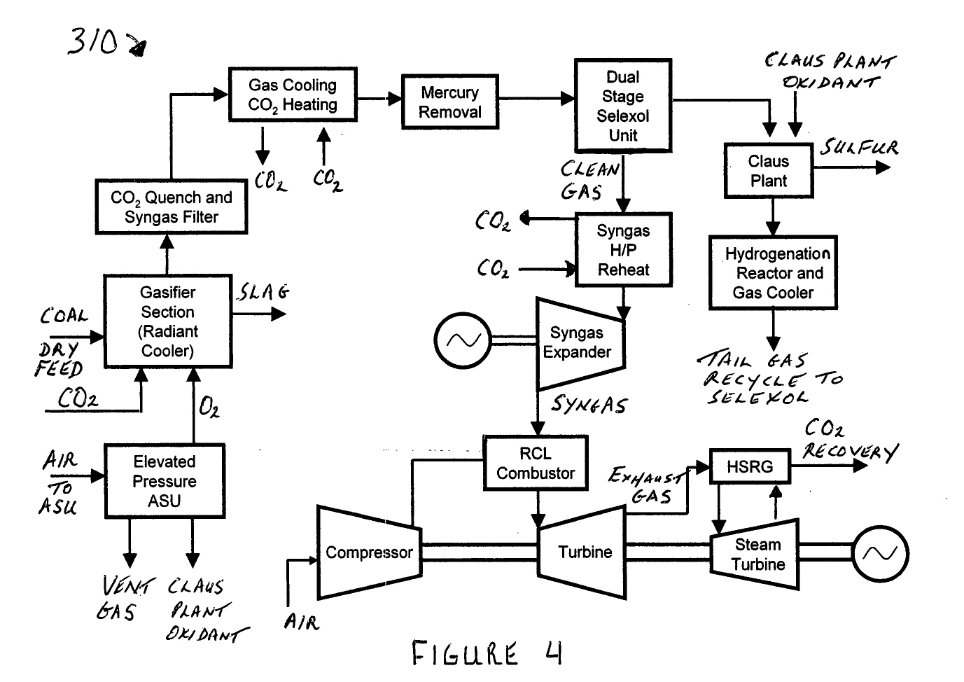

FIG. 4 represents IGCC system 310 in accordance with the present invention a system employing a conventional gas turbine system wherein carbon dioxide is recovered from the exhaust using known technology such as an amine scrubber or any other known CO₂ recovery system.

Although the invention has been described in considerable detail, it will be apparent that the invention is capable of numerous modifications and variations, apparent to those skilled in the art, without departing from the spirit and scope of the invention.

1. A method of operating an oxygen-blown gasifier comprising:
a) passing to the gasifier a supply of coal;
b) passing to the gasifier a supply of carbon dioxide in a mole ratio of at least about two moles of carbon dioxide per ten moles of carbon in the coal;
c) passing to the gasifier a supply of oxygen to maintain a gasifier temperature in excess of the melting point of the ash in the coal; and
d) reacting the coal with the oxygen and carbon dioxide to produce a product fuel gas comprising more moles of carbon monoxide than moles of carbon in the coal.

2. The method of claim 1 wherein the carbon monoxide-containing product fuel gas is fed as fuel to a power generation apparatus.

3. The method of claim 2 wherein the power generation apparatus comprises a gas turbine.

4. The method of claim 3 wherein the gas turbine further comprises a combustor having a rich catalytic reactor for reaction of the fuel prior to downstream combustion.

5. The method of claim 3 wherein the gas turbine exhaust is fed to a heat recovery boiler producing steam and a cooled effluent gas.

6. The method of claim 5 wherein carbon dioxide is recovered from the effluent gas.

7. The method of claim 3 wherein the product fuel gas is expanded in a turbine to recover energy prior to combustion in the gas turbine.

8. The method of claim 2 wherein the power generation apparatus comprises a fuel cell.

9. The method of claim 8 wherein the product fuel gas is expanded in a turbine to recover energy prior to reaction in the fuel cell.

10. The method of claim 8 wherein the carbon monoxide product is fed as fuel to an oxygen transport fuel cell.

11. The method of claim 10 wherein an anode gas bleed stream is combusted with high purity oxygen.

12. The method of claim 1 wherein the product fuel gas is at a pressure greater than about thirty atmospheres.

13. The method of claim 1 wherein the carbon monoxide-containing product fuel gas is cooled prior to mercury and sulfur recovery.

14. The method of claim 1 wherein carbon dioxide is produced by combustion of the product fuel gas with oxygen separated from air.

15. The method of claim 1 wherein molecular hydrogen from the coal is recovered by permeation through a hydrogen permeable membrane.

16. The method of claim 1 wherein the coal is dry.

17. A method of maximizing the production of electrical energy from coal comprising:
a) providing a supply of coal, oxygen, and carbon dioxide;
b) reacting the coal with the oxygen and carbon dioxide to form more moles of carbon monoxide than moles of carbon in the reacted coal, and thereby producing a product fuel gas;
c) separating the product fuel gas from particulate solids to produce a filtered product fuel gas; and
d) feeding the filtered product fuel gas as fuel to a power generation apparatus.

18. The method of claim 17 wherein the power generation apparatus comprises a gas turbine.

19. The method of claim 17 wherein the power generation apparatus comprises a fuel cell.

20. The method of claim 17 wherein the filtered product fuel gas is cooled prior to feeding the filtered product fuel gas as fuel to the power generation apparatus.

21. The method of claim 20 wherein the product fuel gas is cooled by heat exchange with carbon dioxide.

22. The method of claim 20 wherein mercury and sulfur are removed from the cooled product fuel gas.

23. The method of claim 17 wherein the carbon dioxide is preheated by heat exchange with the product fuel gas.

24. The method of claim 20 wherein the product fuel gas is cooled by admixture with carbon dioxide.

25. The method of claim 22 wherein hydrogen is recovered from the product fuel gas.

26. A method of maximizing the production of electrical energy from coal comprising:
a) providing a supply of coal, oxygen, and carbon dioxide; and
b) reacting the coal with the oxygen and carbon dioxide to form a product fuel gas comprising carbon monoxide and hydrogen derived from the coal and further comprising less than about thirty percent unconverted carbon dioxide.
